(19) United States
(12) Patent Application Publication
(10) Pub. No.: US 2007/0288298 A1
(43) Pub. Date: Dec. 13, 2007

(54) System and method for behaviorally targeting electronic communications

(76) Inventors: Chris Gutierrez, Overland Park, KS (US); Ning Xue, Des Plaines, IL (US)

Correspondence Address: LATHROP & GAGE LC, 2345 GRAND AVENUE, SUITE 2800, KANSAS CITY, MO, 64108, US

(21) Appl. No.: 11/449,306

(22) Filed: Jun. 8, 2006

(51) Int. Cl. G06F 17/30

(52) U.S. Cl. 705/10

(57) ABSTRACT

Methods and systems for determining the correlation between electronic informational campaigns, for example, two advertising campaigns by a two phase process, based on the behavior of multiple users. In a first phase, probabilities of one campaign, with respect to another campaign, are calculated, and values of expected revenue for each campaign are determined from the probabilities. The campaigns with the greatest expected revenues are then analyzed, to determine the extent of their correlation, in the second phase. In the second phase, the correlation between two campaigns is determined, by determining a correlation value, indicative of the correlation between two campaigns.

### REFERENCE TO LARGE TABLE APPENDIX

This specification is accompanied by a Large Table Appendix, provided in the attached CD-R (CD-ROM) in ASCII characters. This CD-R is submitted herewith as Appendix A, in duplicate. Appendix A includes an electronic file entitled Table 1.txt, created Jun. 6, 2006, which is 329 KB. Appendix A is incorporated by reference herein, as though fully replicated herein.

### TECHNICAL FIELD

The present invention is directed to the field of the electronic communications over wide area public networks, such as the Internet, and, in particular, to determining the various users to send electronic communications, based on their responses to previously sent electronic communications.

### BACKGROUND

Advertising on the Internet is growing at rapid rate. By 2007, it is expected that companies will allocate up to twenty-five percent of their advertising budget for Internet advertising. Internet advertising is typically accomplished through advertisements placed into web pages, pop-ups and banners. It is also achieved through electronic mail, commonly referred to as, e-mail. One method of sending advertising over electronic mail is disclosed in commonly owned U.S. patent application Ser. No. 10/915,975, entitled: Method And System For Dynamically Generating Electronic Communications (U.S. Patent Application Publication No. 2005/0038861 A1), this patent application and Patent Application Publication, are incorporated by reference herein. U.S. patent application Ser. No. 10/915,975, entitled: Method And System For Dynamically Generating Electronic Communications and U.S. Patent Application Publication No. 2005/0038861 A1, are used interchangeably herein.

As potential customers respond to Internet advertisements, the advertisers seek ways in which they can keep a captive customer's attention, to sell them other products, that they may also be interested in. In other words, Internet advertisements are targeted to specific groups based on their online interactions, as they travel within a web site or between multiple web sites. This is known as behavioral targeting.

Behavioral targeting is a practice that allows marketers to segment their audience into manageable groups, to deliver the right message to the right person at the right time. It also allows for the better management of the relationship between the marketer and their customers. Behavioral targeting utilizes integrated data from various sources to create a comprehensive profile of a customer that can be targeted using numerous delivery mechanisms.

For example, a person who responds to an advertisement for a gym, may also be receptive to advertisements for organic foods. Advertisers see behavioral targeting as a growth area, for it allows them to market to a smaller circle of customers, but these customers are more likely to buy the goods or services, than randomly sending or placing an advertisement on the Internet.

A major disadvantage to contemporary behavioral targeted Internet advertising is that it uses cookies. Cookies are information that a targeted web site puts on a user's hard disk so that it can remember something about the user at a later time. Specifically, cookies are information for future use that are stored by a server on the client side of a client/server communication. Typically, a cookie records a user's preferences when using a particular site. Using the Web's Hypertext Transfer Protocol (HTTP), each request for a Web page is independent of all other requests. For this reason, the Web page server has no memory of what pages it has sent to a user previously or anything about your previous visits.

Cookies serve as mechanisms that allow servers to store information about a user on the user's own computer. Users can view the cookies that have been stored on their hard disk. The location of the cookies depends on the browser or browsing application. Internet Explorer® stores each cookie as a separate file under a Windows subdirectory. Netscape® stores all cookies in a single cookies.txt file. Opera® stores them in a single cookies data file.

Cookies are commonly used to rotate banner ads that a web site sends to a user, so it does not keep sending the user the same banner advertisement for each of the user's requested web pages. Cookies can also be used to customize web pages for particular users, based the user's browser type or other information, the user provided to the Web site. Web users must agree to let cookies be saved for them, but, in general, it helps Web sites to serve users better.

However, most online users do not view cookies favorably. Rather, cookies are viewed as an invasion of privacy. Moreover, these users take great measures to eliminate cookies on the web browsers, deleting cookies that come onto their Web browser frequently, and in many cases, daily.

### SUMMARY

The present invention provides systems and methods for behavioral targeting customers in order to send them information or advertising, to which they will be responsive. The system achieves its objectives, typically without cookies.

The invention typically involves a two phase process. It is based on user's behavior in responding to various informational or advertising campaigns. These campaigns are conducted electronically, and are typically in the form of electronic mail or e-mail.

In a first phase, probabilities of one informational campaign, typically an advertising campaign, with respect to another informational, typically an advertising campaign, are calculated, and values of expected revenue for each campaign are determined from the probabilities. The campaigns with the greatest expected revenues are then analyzed, to determine the extent of their correlation, in the second phase. By performing the process in two phases, false positives are nearly eliminated, and only the most relevant advertising campaigns are ultimately evaluated. This provides advertisers with a highly targeted audience, for whom to send their advertising communications, typically in the form of electronic mail (email).

In the second phase, the correlation between two campaigns is determined, by determining a correlation value, indicative of the correlation between two campaigns. This phase involves determining a correlation coefficient between two campaigns, and analyzing the correlation coefficient for a lower confidence limit (LCL), expressed as a value, of a confidence interval. The value of the LCL is used in determining if another informational campaign will be sent to the users who received a previous informational campaign.

An embodiment of the invention is directed to a method for determining the correlation between information to be distributed to recipients. The method includes, sending a first electronic communication, for example, an electronic mail (e-mail), corresponding to first information (for example, a first advertising campaign) to a plurality of recipients. The first electronic communication is designed to be responded to. A second electronic communication, for example, an electronic mail (e-mail), corresponding to second information (for example, a second advertising campaign) is sent to at least substantially all of the plurality of recipients of the first electronic communication, the second electronic communication is also designed for being responded to. Responses are received to the first electronic communication and the second electronic communication, and the received responses to the first electronic communication and the second electronic communication from the plurality of recipients, and non-responses to the first electronic communication and the second electronic communication from the plurality of recipients, are tabulated. Based on the tabulation, a correlation value between the first information and the second information is determined. This correlation value is indicative in determining if other information will be sent to recipients or users who received previous information.

Another embodiment of the invention is directed to a method for distributing informational campaigns, such as advertising campaigns. The method includes, sending a plurality of recipients e-mails for a first informational campaign and a second informational campaign, the e-mails subject to responses from users, from a non-responded to status, to an opened status, to an activated status, where the recipient has opened the e-mail and the browser associated with the recipient has been directed to a target web site associated with the opened e-mail. The e-mails are monitored for their status, and values are assigned to the e-mails for the first informational campaign and the second informational campaign, in accordance with the monitored status of the e-mails. A correlation value between the first informational campaign and the second informational campaign is determined based on values assigned to the e-mails for the first and second informational campaigns. This correlation value is indicative in determining if another informational campaign will be sent to recipients or users who received a previous informational campaign.

Another embodiment of the invention is directed to a method for distributing informational campaigns. The method includes, providing a plurality of informational campaigns and determining the expected revenue for each campaign. For each campaign having an expected revenue above a predetermined monetary value, first and second informational campaigns, for example, advertising campaigns, are designated. Plural recipients are sent e-mails for the first informational campaign and the second informational campaign. The e-mails are subject to responses from recipients (users), from a non-responded to status, to an opened status, to an activated status, where the recipient has opened the e-mail and the browser associated with the recipient has been directed to a target web site associated with the opened e-mail. The e-mails are then monitored for their status, and values are assigned to the e-mails for the first informational campaign and the second informational campaign, in accordance with the monitored status of the e-mails. A correlation value between the first informational campaign and the second informational campaign is determined, based on values assigned to the e-mails for the first and second informational campaigns. This correlation value is indicative in determining if another informational campaign will be sent to recipients or users who received a previous informational campaign.

Another embodiment of the invention is directed to a system for determining the correlation between informational campaigns, for example, advertising campaigns, to be sent to recipients. The system includes, but is not limited to, four components. There is a first component configured for sending a first electronic communication corresponding to a first informational campaign to a plurality of recipients, the first electronic communication being configured for being responded thereto, and for sending a second electronic communication corresponding to a second informational campaign to at least substantially all of the plurality of recipients of the first electronic communication, the second electronic communication being configured for being responded thereto. The first and second electronic communications are, for example, e-mails. There is a second component for receiving responses to the first electronic communication and the second electronic communication from the first component. A third component serves to tabulate the received responses to the first electronic communication and the second electronic communication from the plurality of recipients, and non-responses to the first electronic communication and the second electronic communication from the plurality of recipients, from the second component. There is a fourth component for determining a correlation value between the first informational campaign and the second informational campaign, based on the tabulated responses and non-responses, from the third component. This correlation value is indicative in determining if another informational campaign will be sent to recipients or users who received a previous informational campaign.

Still another embodiment of the invention is directed to a computer-usable storage medium. The storage medium has a computer program embodied thereon for causing a suitably programmed system to determine the correlation between two informational campaigns, for example, advertising campaigns, by performing the following steps when such program is executed on the system. The steps include, sending a first electronic communication corresponding to a first informational campaign to a plurality of recipients, the first electronic communication being configured for being responded thereto, and sending a second electronic communication corresponding to a second informational campaign to at least substantially all of the plurality of recipients of the first electronic communication, the second electronic communication being configured for being responded thereto. The first and second electronic communications are, for example, electronic mail or e-mail. The next step includes, receiving responses to the first electronic communication and the second electronic communication, followed by tabulating the received responses to the first electronic communication and the second electronic communication from the plurality of recipients, and non-responses to the first electronic communication and the second electronic communication from the plurality of recipients, and, determining a correlation value between the first informational campaign and the second informational campaign, based on the tabulated responses and non-responses. This correlation value is indicative in determining if another informational campaign will be sent to recipients or users who received a previous informational campaign.

### BRIEF DESCRIPTION OF THE DRAWINGS

Attention is now directed to the drawings, where like reference numerals or characters indicate corresponding or like components. In the drawings:

FIG. 1 is a diagram of an exemplary system on which embodiments of the invention are performed;

FIG. 2A is a screen shot showing electronic mail (e-mail) communications in the mailbox of a recipient in accordance with an embodiment of the invention;

FIG. 2B is the screen shot of FIG. 2A when a user has decided to open one of the e-mail communications in the mailbox;

FIGS. 3A and 3B are screen shots of the text of e-mails received in accordance with the present invention;

FIG. 4 is a screen shot showing a web page accessed from a redirect uniform resource locator in accordance with an embodiment of the invention;

FIG. 5A is a diagram used in determining the probability of predictor advertising campaigns and target advertising campaigns in accordance with an embodiment of the invention;

FIG. 5B shows an application of the diagram of FIG. 5A;

FIG. 6 is an example chart of probabilities for predictor and target campaigns;

FIG. 7A is a diagram used in determining the campaigns that will be subjected to the correlation phase of an embodiment of the invention;

FIG. 7B is the diagram of FIG. 7A, showing an exemplary operation of an embodiment of the invention;

FIG. 8 is a diagram of exemplary responses to various campaigns used to perform a second phase in accordance with an embodiment of the invention; and,

FIG. 9 is a matrix of the diagram of FIG. 8 as used in determining the correlation coefficients of two campaigns in accordance with an embodiment of the invention.

This document also includes a Large Table Appendix on a Compact Disk (disclosed above) as Appendix A, and Appendix B, that is attached to this document.

### DETAILED DESCRIPTION OF THE DRAWINGS

The present invention is related to systems and methods for behavioral targeting of users along a network such as the Internet, for various informational campaigns, such as advertising campaigns. The invention typically involves a two phase process.

In a first phase, probabilities of one informational campaign, typically an advertising campaign, with respect to another informational, typically an advertising campaign, are calculated, and values of expected revenue for each campaign are determined from the probabilities. The campaigns with the greatest expected revenues are then analyzed, to determine the extent of their correlation, in the second phase. By performing the process in two phases, false positives are nearly eliminated, and only the most relevant advertising campaigns are ultimately evaluated. This provides advertisers with a highly targeted audience, for whom to send their advertising communications, typically in the form of electronic mail (e-mail).

In the second phase, the correlation between two campaigns is determined. The correlation is expressed as a value. This phase involves determining a correlation coefficient between two campaigns, and analyzing the correlation coefficient for a lower confidence limit (LCL), expressed as a value, of a confidence interval.

The value of the correlation coefficient is used in determining if another informational campaign will be sent to the users, who received a previous informational campaign. The value of the correlation coefficient is in a range of −1 to 1. For example, the preferred values for the correlation coefficient are those as close as possible to 1.

From the correlation coefficient, a lower confidence limit (LCL) is calculated. The largest LCL (value for the LCL) is typically indicative of the campaigns considered to be the most correlated. Similarly, smaller LCLs or LCL values, are considered to have less correlated campaigns. When multiple paired campaigns are evaluated, the LCLs (LCL values) can be ranked, from largest to smallest, with the ranking indicative of the most correlated campaigns. Accordingly, the more correlated campaigns (high LCL) are typically sent to recipients (users) before the less correlated campaigns (low or lower LCL).

Throughout this document, numerous textual and graphical references are made to trademarks. These trademarks are the property of their respective owners, and are referenced only for explanation purposes herein.

Also throughout this document, references are made to “n” and “nth”, to indicate the last member, component, element, etc., of a series, sequence or the like.

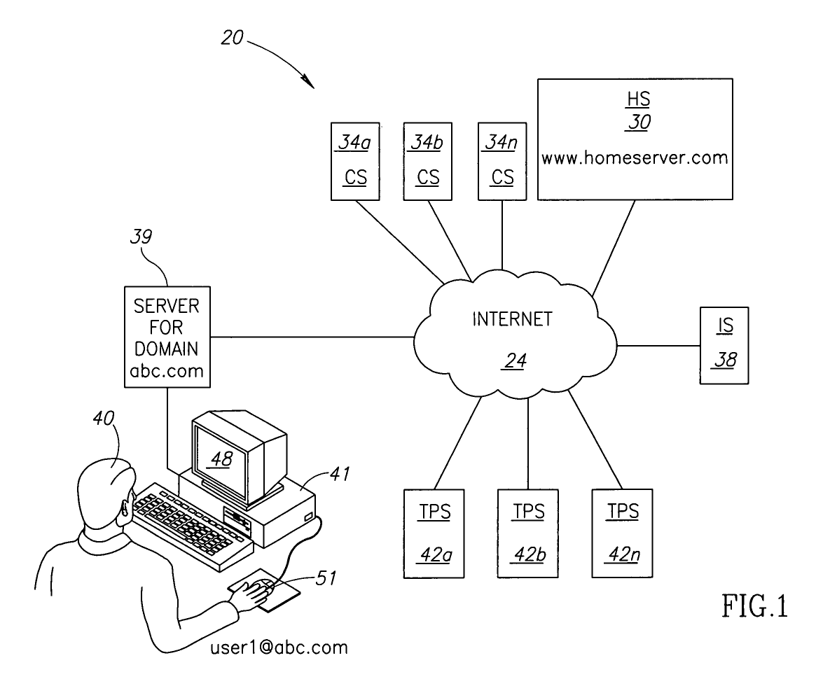

FIG. 1 shows the present invention in an exemplary operation. The present invention employs a system 20, formed of various servers and server components, that are linked to a network, such as a wide area network (WAN), that may be, for example, the Internet 24.

There are, for example, numerous servers that are linked to the Internet 24, as part of the system 20. These servers typically include a Home Server (HS) 30, one or more content servers (CS) 34a-34n, as well as numerous other servers and devices. Depending on the content to be provided to users (in particular, to their computers or other computer-type devices or machines, through their e-mail clients) there may also be imaging servers, such Imaging Server (IS) 38, that along with the servers and related components described herein, are detailed in commonly owned U.S. patent application Ser. No. 10/915,975, entitled: Method And System For Dynamically Generating Electronic Communications (U.S. Patent Application Publication No. 2005/0038861 A1), this patent application and Patent Application Publication, are incorporated by reference herein. U.S. patent application Ser. No. 10/915,975, entitled: Method And System For Dynamically Generating Electronic Communications and U.S. Patent Application Publication No. 2005/0038861 A1, are used interchangeably herein. All of the aforementioned servers are linked to the Internet 24, so as to be in communication with each other. The servers 30, 34a-34 and 38 (depending on the content being sent to users), include multiple components for performing the requisite functions as detailed below, and the components may be based in hardware, software, or combinations thereof. The aforementioned servers may also have internal storage media and/or be associated with external storage media.

The servers 30, 34a-34n, 38 of the system 20 are linked (either directly or indirectly) to an endless number of other servers and the like, via the Internet 24. Other servers, exemplary for describing the operation of the system 20, include a domain server 39 for the domain (for example, the domain “abc.com”) of the user 40 (for example, whose e-mail address is user1@abc.com), linked to the computer 41 (or other computer type device) of the user. Still other servers may include third party servers (TPS) 42a-42n, controlled by content providers and the like.

While various servers have been listed, this is exemplary only, as the present invention can be performed on an endless numbers of servers and associated components, that are in some way linked to a network, such as the Internet 24. Additionally, all of the aforementioned servers include components for accommodating various server functions, in hardware, software, or combinations thereof, and typically include storage media, either therein or associated therewith. Also in this document, the aforementioned servers, storage media, components can be linked to each other or to a network, such as the Internet 24, either directly or indirectly.

The home server (HS) 30 is of an architecture that includes components for handling electronic mail, to perform an electronic mail (e-mail) server functionality, including e-mail applications. The home server (HS) 30 also includes components for recording events, such as the status of e-mails, when e-mails are sent, whether or not there has been a response to an e-mail (a certain time after the e-mail has been sent), whether the e-mail has been opened, and whether the opened e-mail has been activated or “clicked”, such that the browser of the user is ultimately directed to target web site, corresponding to the link that was “clicked.”

The architecture also includes components for providing numerous additional server functions and operations, for example, comparison and matching functions, policy and/or rules processing, various search and other operational engines. The home server (HS) 30 includes various processors, including microprocessors, for performing the aforementioned server functions and operations. The home server (HS) 30 may be associated with additional caches, databases, as well as numerous other additional storage media, both internal and external thereto. The home server (HS) 30 and all components associated therewith are, for example, in accordance with the home server (HS) 30, described in U.S. Patent Application Publication No. 2005/0038861 A1.

The home server (HS) 30 composes and sends e-mails to intended recipients (for example, e-mail clients hosted by a computer, workstation or other computing device, etc., associated with a user), over the network, typically a wide area network (WAN), such as the Internet 24, and sends these e-mails to e-mail clients in computers associated with users. The e-mail clients may be, for example, America Online® (AOL®), Outlook®, Eudora®, or other web-based clients. In this document, the client is an application that runs on a computer, workstation or the like and relies on a server to perform some operations, such as sending and receiving e-mail. Also, for explanation purposes, the Home Server (HS) 30 may have a uniform resource locator (URL) of, for example, www.homeserver.com.

The e-mails, sent by the home server (HS) 30, may be e-mails in accordance with those sent by the home server (HS) 30 in commonly owned U.S. Patent Application Publication No. 2005/0038861 A1. The e-mail may also be “static” e-mails, where the content and underlying links to target web sites are fixed when the e-mail is sent.

For example, the intended recipient or user 40 has a computer 41 (such as a multimedia personal computer with a Pentium® CPU, that employs a Windows® operating system), that uses an e-mail client. The computer 41 is linked to the Internet 24.

Content Servers (CS) 34a-34n (one or more) are also linked to the Internet 24. The content servers (CS) 34a-34n provide content, typically in text form, for the imaging server (IS) 38, typically through the Home Server (HS) 30, and typically, in response to a request from the Home Server (HS) 30, based on a designated keyword. These content servers (CS) 34a-34n may be, for example, Pay-Per-Click (PPC) servers of various content providers, such as internal providers, or external providers, for example, Overture Services, Inc. or Findwhat, Inc.

At least one imaging server (IS) 38 is linked to the Internet 24. The imaging server (IS) 38 functions to convert text (data in text format) from the content servers (CS) 34a-34n, as received through the Home Server (HS) 30, to an image (data in an image format). After conversion into an image, the image is typically sent back to the home server (HS) 30, to be placed into an e-mail opened by the user 40, as detailed below. Alternately, the imaging server (IS) 38 may send the image directly to the e-mail client associated with the user 40, over the Internet 24.

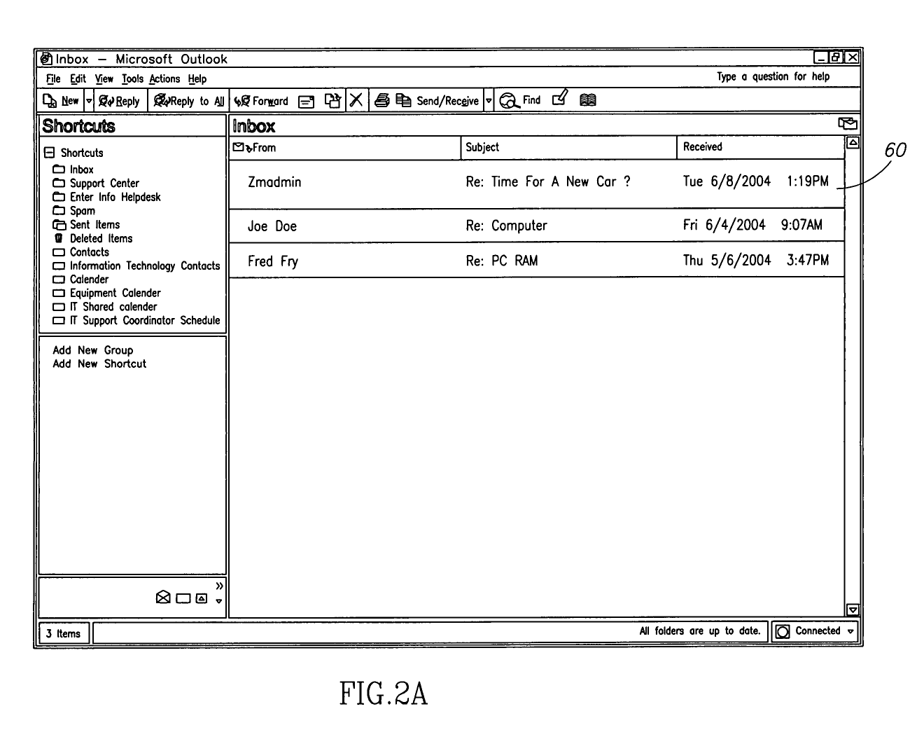

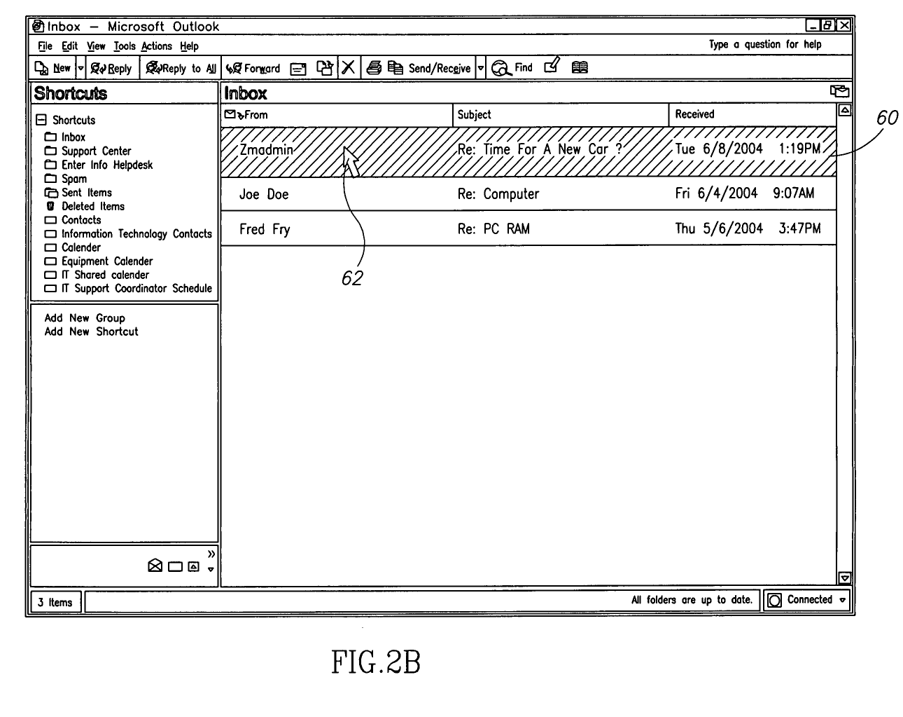

Turning also to FIG. 2A, an e-mail is sent to the e-mail client associated with the computer 41 of the user 40, typically from the Home Server (HS) 30. This e-mail appears in the mailbox of a user, in the form of a line of text 60, identifying the sender, subject and other information. This e-mail 60 is in addition to the other e-mails received in the mailbox 61a, 61b. Once a reference to the e-mail being in a user's mailbox appears as the line of text 60 in the user's mail box, the e-mail is considered to have been “sent” (and is referred to as a “sent e-mail”).

The “sent e-mail” as represented by text line 60, may be, for example, in Hypertext Markup Language (HTML), and may include one or more Hypertext Transport Protocol (HTTP) source requests. These HTTP source requests typically reference the Home Server (HS) 30.

The e-mails sent by the home server (HS) 30, may be in accordance with the e-mails of U.S. Patent Application Publication No. 2005/0038861 A1. It may also be in accordance with the conventional or static e-mail. The text line 60 corresponding to the e-mail sought to be opened, is then opened by activating a mouse or other pointing device, commonly known as “clicking” on the e-mail (the line of text 60 corresponding to the e-mail). The activation or click is indicated by the arrow 62, as shown in FIG. 2B.

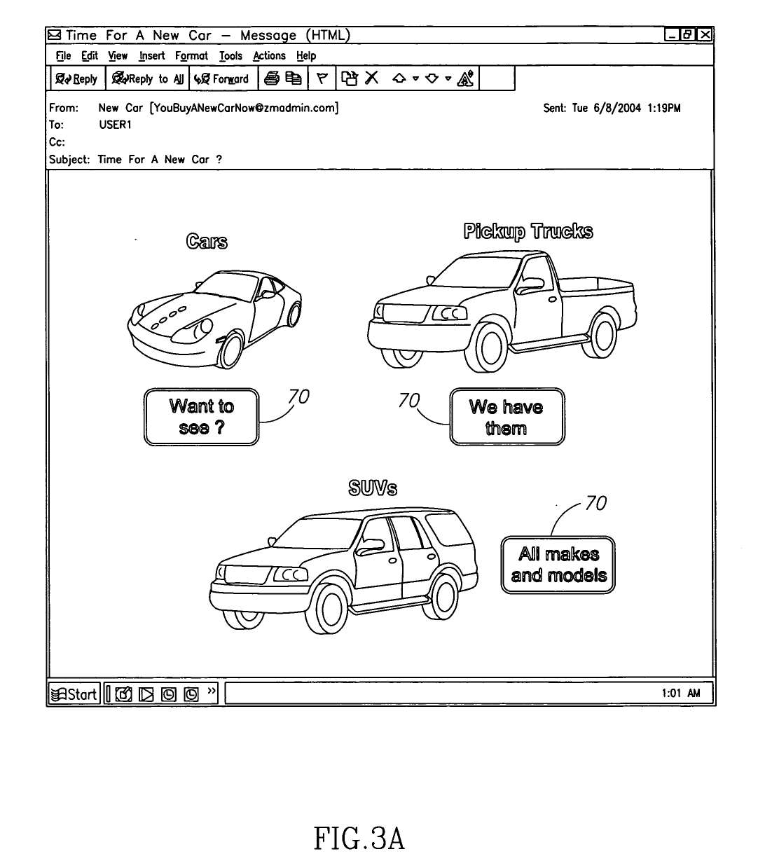

With the e-mail now being opened, templates are built out, resulting in one of the two screen shots of the opened e-mail, as shown in FIGS. 3A and 3B, depending on the type of template and method in which the content of the template is generated. FIG. 3A shows screen shot of a static e-mail, and FIG. 3B shows a screen shot of a dynamic e-mail in accordance with the e-mails disclosed in U.S. Patent Application Publication No. 2005/0038861 A1. With the screen shots of FIG. 3A or 3B having been activated or accessed, and appearing on the monitor or other viewing device associated with the user's e-mail client, the e-mail is considered to be “opened”. This opening of the e-mail is recorded in the home server (HS) 30.

Both opened e-mails include buttons, locations or the like, on the image that covers the links 70 (FIG. 3A), 71 (FIG. 3B). These links 70, 71, when activated by the mouse or other pointing device or “clicked” on, will direct the browser (web browsing application) to the home server (HS) 30, and then, the browser is redirected to a targeted web site. By clicking on the respective links 70, 71, the e-mail is considered to be “clicked”, and the “click” is recorded in the home server (HS) 30.

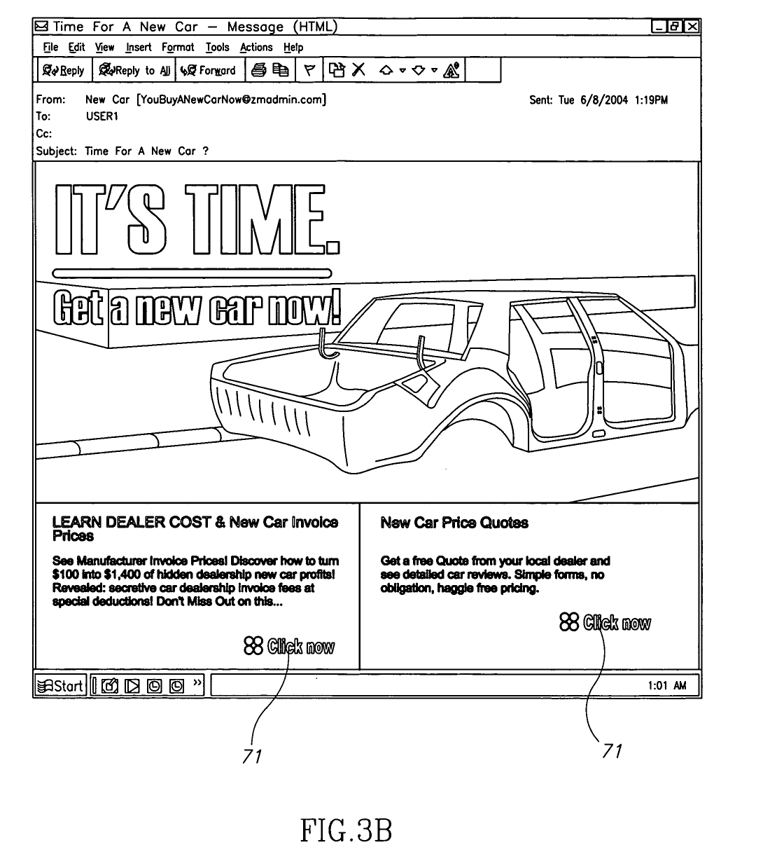

The targeted web site associated with the link is shown, for example, as the screen shot of FIG. 4, and may be hosted, for example on any one of the third party servers (TPS) 42a-42n. Exemplary processes associated with directing the browser of the user to the targeted web site upon clicking on the respective links 70, 71 are detailed in U.S. Patent Application Publication No. 2005/0038861 A1.

While FIGS. 2A, 2B, 3A and 3B show processes associated with a single e-mail, the e-mails, as detailed herein, are typically sent in batches to tens of thousands of users (the e-mail clients associated therewith). These batches of e-mails typically are informational campaigns, and for example, are advertising campaigns, that advertisers (web site promoters) use to being potential customers to their web sites (or web pages), or other targeted web sites (or web pages).

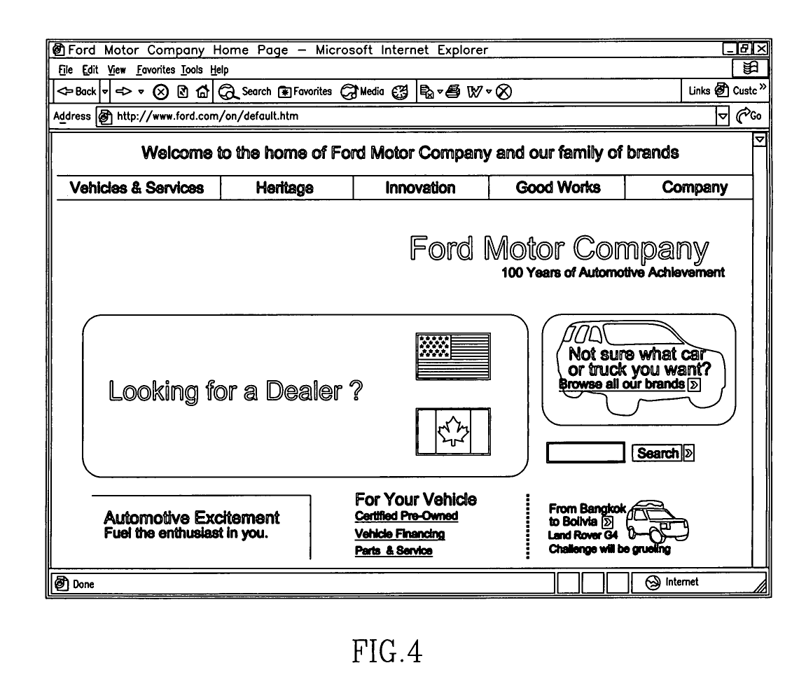

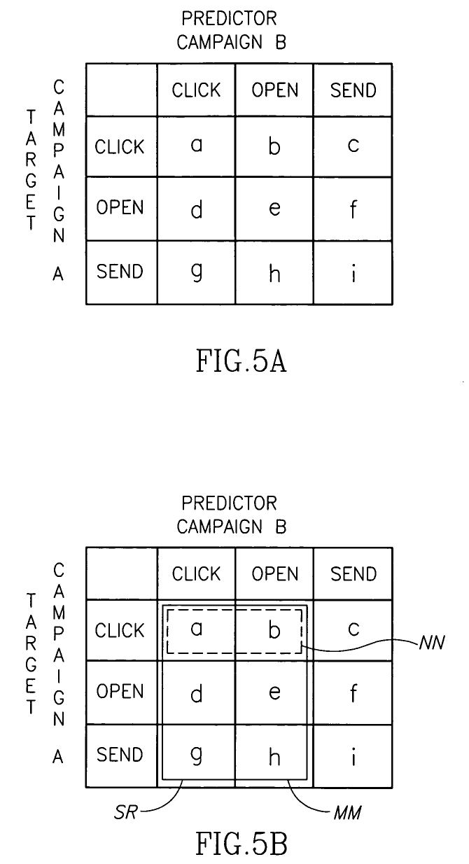

Attention is now directed to FIGS. 5A and 5B, where a process for behavioral targeting users, associated with computers, nodes or the like along the network, is described. The process involves two phases.

In a first phase, probabilities of one informational campaign, typically, an advertising campaign, with respect to another campaign (informational, for example, advertising), are calculated, and values of expected revenue for each campaign are determined from the probabilities. The campaigns with the greatest expected revenues are then analyzed, to determine the extent of their correlation, in the second phase. By performing the process in two phases, false positives are nearly eliminated, and only the most relevant advertising campaigns are ultimately evaluated. This provides advertisers with a highly targeted audience, for whom to send their advertising communications, typically in the form of electronic mail.

To determine the probability of one advertising campaign, with respect to another, and the expected revenue for the respective campaigns, there will be, for example, five advertising campaigns established. These campaigns include: Campaign A, a campaign for Automobiles; Campaign B, a campaign for boats; Campaign C, a campaign for carpet; Campaign D, a campaign for dog toys; and, Campaign E, a campaign for eggs. These campaigns are also referred to throughout this document by their shortened names, A, B, C, D and E. Every campaign is evaluated with respect to every other campaign. For example, A|B represents the probability that a user will respond to a communication, typically, an e-mail, for Campaign A, given that the user has responded to Campaign B in the past. By “responded”, it is meant, that the a user has either “opened”, or, “opened” and “clicked”, collectively “clicked”, the e-mail sent to him. Also, an e-mail is considered “sent” when it was sent but not responded to in a predetermined time period after its having been sent.

In looking at A|B (the probability that a user will respond to a communication, typically, an e-mail, for Campaign A, given that the user has responded to Campaign B in the past), Campaign A is the “target” campaign, while Campaign B is the “predictor” campaign, as shown in FIG. 5A. For example, the probability of A|B is determined in accordance with the diagram of FIG. 5B.

In FIG. 5A, the predictor campaign, Campaign B, and moving horizontally, right to left, are columns for the e-mail for Campaign B, being “sent”, “opened”, and “clicked”, as detailed and defined above. For the Target Campaign, here, Campaign A, and moving vertically, bottom to top, are rows for the e-mail for Campaign A, being “sent”, “opened”, and “clicked”, as detailed and defined above. The columns and rows are combined to form nine spaces, in which a letter a-i has been entered. For example, the space that “a” occupies, corresponds to the number of user's who have “clicked” on e-mails for both Campaign B and Campaign A. While any amount of users is permissible, the diagrams of FIGS. 5A and 5B are typically built based on at least approximately 1000 users being sent e-mails for the Predictor and Target campaigns.

In FIG. 5B, the probability that a user will respond to Campaign A, given that the user has responded to Campaign B in the past, expressed as “P(A|B)”, is determined by taking the number of users who have clicked on the Target Campaign (Campaign A) and responded to the Predictor Campaign (Campaign B), illustrated by the broken line block NN and expressed as “a+b”, from the set (SR) of users who responded to the predictor campaign, over the number of users who have responded to the Predictor Campaign (Campaign B), illustrated by the solid line block MM, and expressed as “a+b+d+e+g+h”. In equation form, this probability P(A|B), is expressed as follows:

P(A|B)=NN/MM=a+b/a+b+d+e+g+h

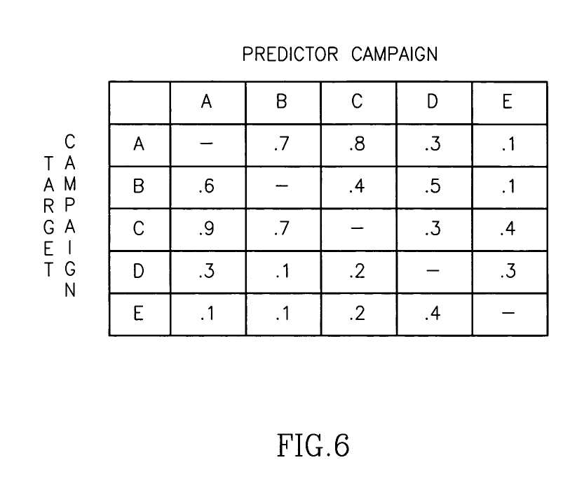

By performing these calculations, the exemplary diagram and result list is obtained in FIG. 6. For example, in this diagram, the probability that a user will respond to Campaign A, given that the user has responded to Campaign B in the past, expressed as “P(A|B)”, is 0.7, while the probability that a user will respond to Campaign B, given that the user has responded to Campaign A in the past, expressed as “P(B|A)” is 0.6.

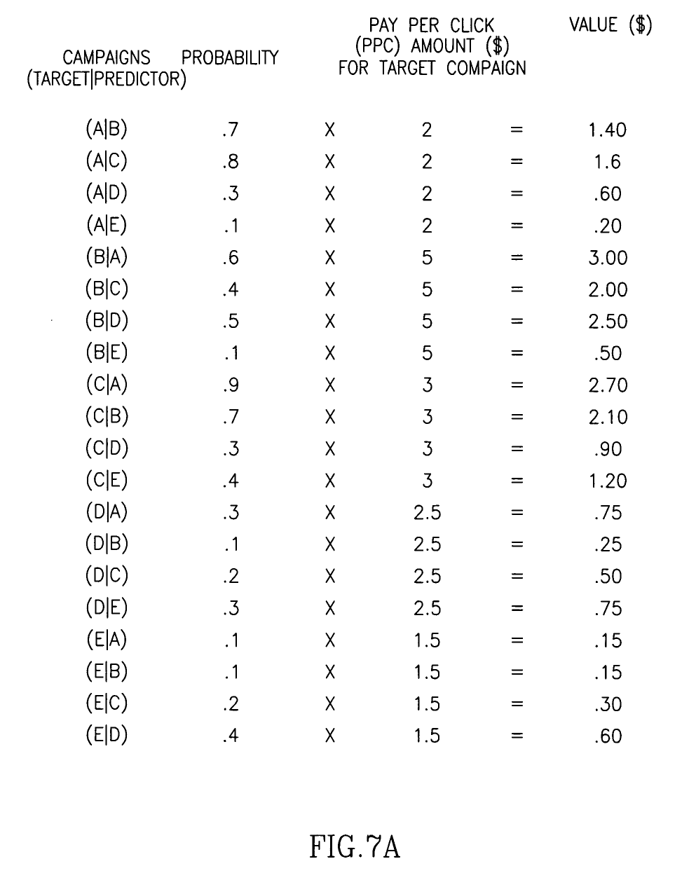

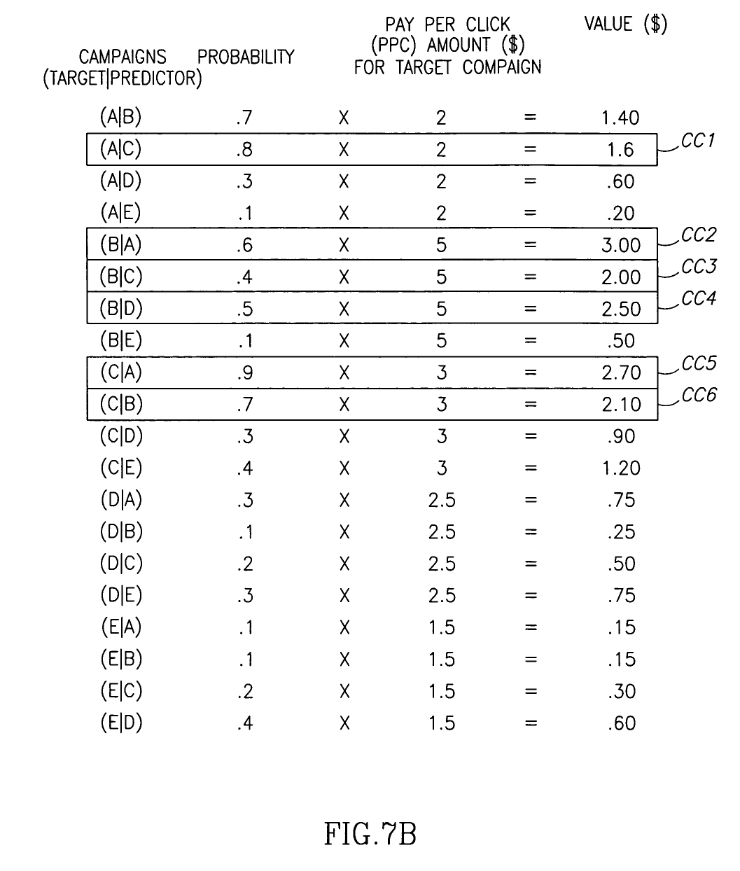

Using the probabilities from FIG. 6, the Table of FIG. 7A is developed. In this Table, there is an amount, typically monetary, that a web site promoter or owner of the target web site, will pay when their web page accessed after a corresponding link is “clicked” by a user. This is known as Pay Per Click (PPC), cost per click, etc. For example, the target web page for Campaign A will pay $2 (PPC amount of $2), Campaign B will pay $5, Campaign C will pay $3, Campaign D will pay $2, and Campaign E will pay $1.50. These monetary amounts, multiplied by the probabilities, will yield a return, as a monetary amount or value. It will then be determined the amount of a return or value that is sufficient to move to the second phase of the process, determining the correlation coefficient.

For example, it has been determined that returns of $1.50 or more are sufficient for determining the correlation coefficient. Accordingly, only target campaigns A, B and C, include return amounts of at least $1.50, as indicated by the boxes CC1-CC6 of FIG. 7B (the table of FIG. 7A including the boxes CC1-CC6). It is these three campaigns, A, B and C, that will be subjected to the second phase, the analysis for the correlation component of these campaigns, as detailed below.

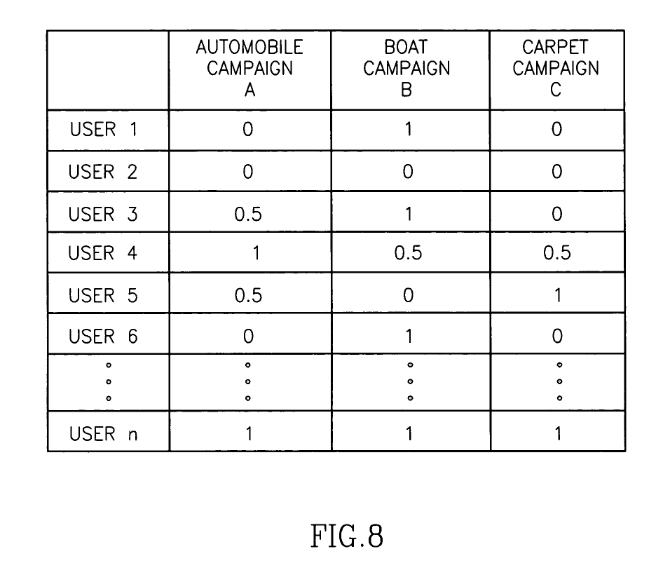

Attention is now also directed to FIG. 8, a diagram illustrating a sampling of results from approximately 1000 users (1000 being sufficient to establish a random sampling), USER 1 to USER n (n is the last user in a series of users), in accordance with an embodiment of the invention. For example, assume that all of the users, USER 1 to USER n, have received the three advertising campaigns, A, B and C, based on the results of the first phase of the process, detailed above. The advertising campaigns (A, B and C) are e-mail based in accordance with the e-mails detailed above, and, for example, all of the users were sent an Automobile Campaign (Campaign A), a boat campaign (Campaign B) and a Carpet Campaign (Campaign C). For example, the automobile campaign (Campaign A) is exemplary of Campaigns B and C, and is represented by the screen shots of FIGS. 2A, 2B, 3A, 3B and 4.

The advertising campaigns are, for example, sent from the home server (HS) 30, and are received by the intended recipients, for example, USER 1 to USER n, in accordance with the dynamic or static e-mail described herein. For example, the sent e-mails may be opened, by the user clicking on the text bar, with this opening resulting in the screen shots of FIG. 3A or 3B, providing for links (that as detailed above, if “clicked” will redirect the browser of the user to a targeted web site). This opening event is recorded by the home server (HS) 30 as an “opening.” The links may then be clicked, with the browser of the user ultimately being directed to the target web site. This clicking event is recorded in the home server (HS) 30 as a “redirect.” Should the user not respond to the e-mail in a predetermined time after it was sent by the home server (HS) 30, this even indicating the lack of response in a predetermined time is recorded in the home server (HS) 30 as a “non-response.”

Staying in FIG. 8, the aforementioned responses from the users, USER 1 to USER n, are provided with values. An “opening” of the e-mail is provided with a value of 0.5, a “click” (open with a click) of the e-mail is provided with the value 1, while a “non-response” is provided a value of 0. For example, USER 3 opened the Automobile Campaign (Campaign A), for a value of 0.5, opened the e-mail and “clicked” on the link therein to be redirected to the targeted web site for the Boat Campaign (Campaign B), for a value of 1, but did not respond to the e-mail (a “non-response”) of the Carpet Campaign (Campaign C), for a value of 0.

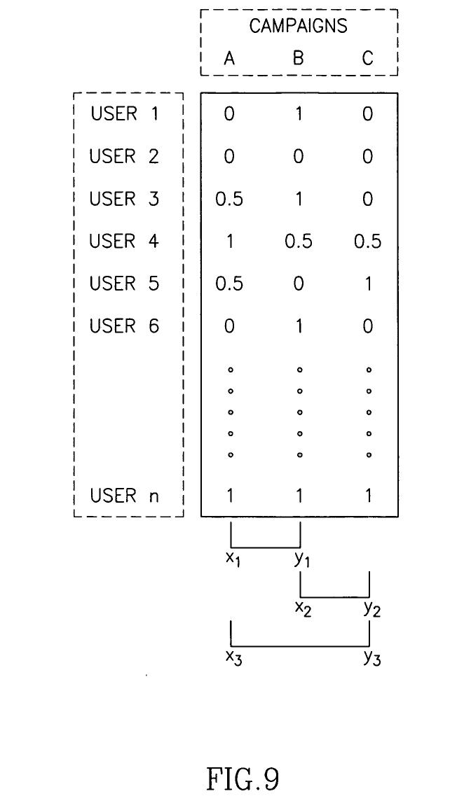

The charted responses of FIG. 8 are now converted into the data matrix of FIG. 9. The headings are shown in broken line boxes for explanation purposes only. This data matrix is an “m by n” matrix, where m represents the number of campaigns, here, for example, Campaigns A-C to be tested, and n represents the number of e-mail users, here, for example, e-mail users (USER 1 to USER n).

The second phase of the process now begins. In this second phase, the correlation between informational or advertising campaigns is determined, as a correlation value is determined for two campaigns. This correlation value provides an indication of the correlation between two campaigns.

Initially, a correlation coefficient will be determined between two campaigns, and each correlation coefficient will be analyzed for a lower confidence limit (LCL), a value that is calculated. This LCL value will be useful in determining which campaigns to send to which users (recipients), and will allow for a ranking of correlated campaigns for sending to users (recipients).

Turning to FIG. 9, correlations between two advertising campaigns are viewed in accordance with correlation vectors, paired as x and y and expressed as (x,y), for example, as (x₁, y₁), (x₂, y₂), (x₃, y₂), as indicated at the matrix. This correlation is represented by the correlation coefficient “r”. The correlation coefficient “r” is a measure of the correlation among two vectors, x and y. The correlation coefficient is expressed as:

r=cov(x,y)/σ(x)σ(y)
where,
cov (x,y) is a correlation vector of one campaign x to another campaign y;
σ(x) is a vector representative of the responses (opens and opens and clicks) to a first campaign;
σ(y) is a vector representative of the responses (opens and opens and clicks) to a second campaign; and,
n is the number of observations (sample or number of users who have been sent both campaigns).

The relationship of the correlation vector (cov (x,y)) to the vectors σ(x) and σ(y), is expressed in the equation:

$$r = \frac{\text{cov} ( x , y )}{σ ( x ) σ ( y )} = \frac{n Σ xy - Σ x Σ y}{[ n Σ {x}^{2} - {( Σ x )}^{2} ] \cdot [ n Σ {y}^{2} - {( Σ y )}^{2} ]}$$

The equation will yield a value of “r”, the correlation coefficient, ranging from −1 to 1. A positive value of the correlation coefficient “r” typically indicates a positive correlation between the two campaigns. Here for example, correlation coefficients “r” are determined for the correlation of Campaign A to Campaign B, the correlation of Campaign B to Campaign C, and, the correlation of Campaign A to Campaign C. Typically, the closer the correlation coefficient (r) is to “1”, the greater the correlation between the two campaigns being analyzed. Also, it is typical that campaigns whose correlation coefficient (r) is negative are not further analyzed.

The accuracy of the Pierson's Correlation Coefficient (r) between the two suitable campaigns, typically having a positive Pierson's Correlation Coefficient (r), is calculated, by applying the Lower Confidence Limit (LCL), expressed as r′, of this value (r). The lower confidence limit (LCL) of the Pierson's Correlation Coefficient (r) is used to rank order the campaigns in order of interest, typically from the highest value to the lowest value. The campaigns associated with the greatest LCL value (r′), are typically delivered first, as these campaigns are the best correlated campaigns, with delivery of the campaigns continuing until all ordered campaigns are exhausted.

The Lower Confidence Limit (LCL) for the Pierson's Correlation Coefficient is calculated, for example, in three steps, using the following method. In the Pearson's correlation coefficient (r), the Lower Confidence Limit (LCL) (r′) is simply the left bound of the confidence interval. The value (r′) for the LCL is typically a value less than 1, and due to the elimination of campaigns with negative correlation coefficients (r), the value for (r′) is typically between 0 and 1.

### Step 1

Convert the value of Pearson's correlation coefficient (r) to a confidence interval (z) as:

$$z = 0.5 ln \frac{1 + r}{1 - r}$$

### Step 2

Calculate the confidence interval of z, expressed as z′, as:

$${z}^{′} = z \pm \frac{a}{\sqrt{N - 3}}$$

where,
a is a value determined from the table of Cumulative Normal Distribution of Appendix B for the desired LCL, typically, between 90% and 99%, and, for example, 97.5%. Using the Table from Appendix B, this value of “a” is 1.96 for an LCL at 97.5%; and,
N is the sample size (number of users).

### Step 3

Convert the confidence interval of z (expressed as z′) to the LCL value of r′ in accordance with the formula:

$${r}^{′} = \frac{{e}^{2 {z}^{′}} - 1}{{e}^{2 {z}^{′}} + 1}$$

The values for the confidence intervals (r′) for the desired LCLs are ranked, with the greatest LCL (r′) values being the most correlated campaigns.

### EXAMPLE

### Part 1—Determining the Expected Revenue of an Advertising Campaign

This Example references the Large Table Appendix (Appendix A) referenced above, and which is incorporated by reference herein. A portion of this Large Table Appendix is Table EX-A.

An Example data set is in the data file, attached to this document on a CD in ASCII language, as Appendix A. In this data set, that forms Table EX-A, there are nine columns representing nine advertising campaigns, from “Art Supplies” to “Vacations.” There are 10,000 rows representing 10,000 users (user01 to user10000). All users were sent all campaigns in e-mails, and have either responded to or not responded to the campaigns. Responses were classified as two kinds, an opening, where the user opened the communication for the campaign, and opened and “clicked.” A user must open an e-mail to click.

A subset of the first ten records of the data set (the Large Table Appendix-Appendix A) for users01-10, is listed in Table EX-A′. In this Table, an e-mail delivery with no response (not opened) is denoted with a value of 0. A delivery with an open but no click is denoted with a value of 0.03, while an e-mail delivery with an open and a click is denoted with a value of 1, such that Table EX-A′ is as follows:

TABLE EX-A′

| | Art | | | | Credit | Office | | | |
|---|---|---|---|---|---|---|---|---|---|
| | Supplies | Books | Boats | Cars | Cards | Supplies | Shoes | Toys | Vacations |
| user01 | 0.03 | 0.03 | 0 | 0.03 | 0.03 | 0 | 0 | 0 | 0 |
| user02 | 0.03 | 0.03 | 0.03 | 0 | 0 | 0 | 0 | 0 | 0.03 |
| user03 | 0.03 | 0.03 | 0.03 | 0 | 0 | 0 | 0 | 0 | 0 |
| user04 | 1 | 1 | 0.03 | 0.03 | 0.03 | 0 | 0 | 0 | 0 |
| user05 | 0 | 0 | 0.03 | 0 | 0 | 0 | 0 | 0 | 0 |
| user06 | 0 | 0.03 | 0 | 0.03 | 0.03 | 0 | 0 | 0 | 0 |
| user07 | 0.03 | 0.03 | 0.03 | 0 | 0 | 0 | 0.03 | 0.03 | 0.03 |
| user08 | 0 | 0.03 | 0 | 0.03 | 0.03 | 0.03 | 0 | 0 | 0 |
| user09 | 0 | 0 | 0 | 0 | 0 | 0 | 0 | 0 | 0.03 |
| user10 | 0.03 | 0.03 | 0.03 | 0.03 | 0.03 | 0.03 | 0.03 | 0.03 | 0.03 |

From Table EX-A (and Table EX-A′), user01 responded to the various e-mails for each campaign as follows:
Received, but did not respond to (open, or open and click): Boats, Office Supplies, Shoes, Toys, or the Vacations campaigns (a no response or “0” value);
Received and responded to, by opening, but did not click: Art Supplies, Books, Cars, and Credit Cards campaigns (open but no click or 0.03 value); and
Did not click on any campaigns.

Also from Table EX-A (and Table EX-A′), user04 responded to the various e-mails for each campaign as follows:
Received, but did not respond to (open, or open and click): Office Supplies, Shoes, Toys, or the Vacations campaigns (a no response or “0” value);
Received and responded to, but did not click: Boats, Cars, and Credit Cards campaigns (an open but no click or 0.03 value); and
Responded to by opening and clicking on the Art Supplies and Books campaigns (an open and click or 1 value).

Next, pay per click (PPC) values were provided. A PPC value is the amount of money that will be paid by an advertiser to a search engine or the like for directing a user to the advertiser's target website, when the user clicks on a link to the target web site provided by the search engine. The PPC values for each campaign were provided in List 1, as follows:

TABLE EX-B

| CAMPAIGN | PPC VALUE ($) |
|---|---|
| Art Supplies | $0.32 |
| Books | $1.44 |
| Boats | $1.75 |
| Cars | $0.04 |
| Credit Cards | $0.18 |
| Office Supplies | $0.05 |
| Shoes | $1.40 |
| Toys | $0.15 |
| Vacations | $1.57 |

A conditional probability P_{cond} of a user clicking on one campaign (C1), given they responded to another campaign (C2) is given by the following equation:

P_{cond}=(users that clicked on C1+users who responded to C2)/(Total number of users that responded to C2).

Using the “Art Supplies” and “Books” campaigns, the conditional probability (P_{cond(ArtSup-Books)} of a user clicking on the Art Supplies campaign, given that they responded (opened OR opened and clicked) on the Books campaign can be given by the following equation:

P_{cond(ArtSup-Books)}=(Number of user users that clicked on the “Art Supply” campaign AND responded to the “Books” campaign)/(Number of users that responded to the Books campaign).

From the Table (TABLE EX-A) of the Large Table Appendix, the following table, known as Table EX-C, was created, as follows:

TABLE EX-C

| | | | Sent but did not |
|---|---|---|---|
| | Clicked Books | Opened Books | respond to Books |
| Clicked Art | 990 | 255 | 0 |
| Supplies | | | |
| Opened Art | 239 | 2578 | 267 |
| Supplies | | | |
| Sent but did not | 0 | 248 | 5423 |
| respond to Art | | | |
| Supplies | | | |

Using the values from Table EX-C, the conditional probability of a user clicking on the Art Supplies campaign, given that they responded to the “Books” campaign P_{cond(ArtSup-Books)} is determined as follows:

P_{cond(ArtSup-Books)}=(990+255)/(990+239+0+255+2578+248)=0.2889

A value for expected revenue (ER) is now determined based on the probability of the user clicking on the Art Supply Campaign given they responded to the Books Campaign. This expected revenue (ER) value is determined by the formula:

ER=P_{cond}PPC

Here, for the specific campaigns of Art Supplies being delivered to users who responded to the “Books” campaign, the expected revenue (ER) is determined in accordance with the formula:

ER=P_{cond(ArtSup-Books)}PPC_{ArtSupplies,} or

ER=0.2889$0.32=$0.09

Therefore, the expected revenue (ER) of the Art Supply Campaign as delivered to users who responded to the Books Campaign is $0.09.

### Part 2—Adjusting the Expected Revenue Based on Sample Size

An important factor in the calculation of Part 1 that was ignored was the sample size. For Example, suppose there was a pair of campaigns (Campaign A and B) with the Table EX-D, listed as follows:

TABLE EX-D

| | | | Sent but did not |
|---|---|---|---|
| | Clicked B | Opened B | respond to B |
| Clicked A | 1 (ax) | 1 (bx) | 1 (cx) |
| Opened A | 1 (dx) | 1 (ex) | 1 (fx) |
| Sent but did not | 1 (gx) | 1 (hx) | 1 (ix) |
| respond to A | | | |

The probability P(A|B)₁ a user would click on A (ax, bx) given that they responded to B (ax, bx, dx, ex, gx, hx) would be: (1+1)/(1+1+1+1+1+1)= 2/6=0.33.

The same probability would come from the following table:

TABLE EX-E

| | | | Sent but did not |
|---|---|---|---|
| | Clicked B | Opened B | respond to B |
| Clicked A | 1000 (ay) | 1000 (by) | 1000 (cy) |
| Opened A | 1000 (dy) | 1000 (ey) | 1000 (fy) |
| Sent but did not | 1000 (gy) | 1000 (hy) | 1000 (iy) |
| respond to A | | | |

The probability P(A|B)₂ a user would click on A (ay, by) given that they responded to B (ay, by, dy, ey, gy, hy) would be:

(1000+1000)/(1000+1000+1000+1000+1000+1000)=2000/6000=0.33.

The estimate of the probability is the same in the above two cases, but the confidence in the estimate is different. In general, more data yields greater confidence in the estimate.

### Part 3—Determining the Confidence in a Sample

One method to quantify a level of certainty in an estimate is to establish a confidence interval (CI). The confidence interval (CI) is the proportion of samples of a given size that may be expected to contain the true mean. For example, in a 90% confidence interval (CI), for the number of samples collected and the confidence interval is computed, over time, 90% of these intervals would contain the true mean.

A 90% Lower Confidence Limit (LCL) is an interval that ranges from a first positive value, upward, to infinity. That is, 90% of the means would fall above the LCL. An important feature of this is that the LCL provides a level of certainty. The less certainty about the estimate, the lower the value must be to ensure that 90% of samples would be above this value. This property is used to account for variances in samples, such as those of Table A. The 90% Lower Confidence Limit (LCL) of the Binomial Distribution is calculated for the sample. This value is substituted for the probability.

Here, the 90% LCL was calculated as follows:
In the examples above the probability P(A|B)₁, P(A|B)₂ was 0.33 for both samples.
The LCL was calculated as follows:

LCL=P(A|B)−1.645[(P(A|B))(1−P(A|B))/6]^{1/2}
whereby, the LCL for the 6 sample test was calculated as:

LCL₆ₛₐₘₚₗₑₛ=(⅓)−1.645[(⅓)(1−⅓)/6]^{1/2}=0.017
while the LCL for the 6000 sample test was calculated as:

LCL₆₀₀₀ₛₐₘₚₗₑₛ=(⅓)−1.645[(⅓)(1−⅓)/6000]^{1/2}=0.323
and, the LCL for Art Supply campaign being delivered to the users who responded to the Books campaign is:

$$\begin{matrix}{LCL}_{( ArtSup \text{-} Books )} = ( 0.2888631 ) - 1.645 \cdot [ ( 0.2888631 ) \cdot \\ { ( 1 - 0.2888631 ) / 4310 ) ]}^{1 / 2} \\ = 0.2775065 .\end{matrix}$$

From List 1 above, the PPC for the Art Supplies Campaign is $0.32. The adjusted expected value is therefore: 0.2775065$0.32=$0.08.

The above is sufficient to deliver e-mail, as it is above a predetermined threshold, here $0.001.

### Part 4A—Analysis of Most Relevant Campaigns, Determining the Correlation Coefficient

In an additional procedure, the campaigns were analyzed to provide users with the most relevant campaigns. Once the non-profitable campaigns were removed, based on the previous procedures, as detailed above, the Pierson's Correlation Coefficient (r) was calculated to determine what campaign the particular user was most interested in, regardless of PPC.

The Pearson's Correlation Coefficient (r) is expressed as follows:

$$r = \frac{Σ XY - \frac{Σ X Σ Y}{N}}{\sqrt{( Σ {X}^{2} - \frac{{( Σ X )}^{2}}{N} ) ( Σ {Y}^{2} - \frac{{( Σ Y )}^{2}}{N} )}}$$

where, X=responses and non-responses to any first campaign,
Y=responses and non-responses to any second campaign being compared to the first campaign, and,
N=the number of observations (sample size-number of users who have been sent both campaigns).

Taking the data from Table A, the Pierson's Correlation Coefficient (r) between the Art Supplies and Books campaigns is calculated as 0.7812.

The accuracy of the Pierson's Correlation Coefficient (r) between the Art Supplies and Books campaigns is further analyzed, by applying the Lower Confidence Limit (LCL), expressed as r′ (below), of this value (r). The lower confidence limit (LCL) of the Pierson's Correlation Coefficient (r) is used to rank order the campaigns in order of user interest, typically from the highest value to the lowest value. The campaigns associated with the greatest LCL (r′) value, are typically delivered first, as these campaigns are the best correlated campaigns, with delivery of campaigns continuing until all ordered campaigns are exhausted.

The Lower Confidence Limit (LCL) (r′) for the Pierson's Correlation Coefficient (r) was calculated using the following method:

### Part 4B—Analysis of Most Relevant Campaigns, Determining the Lower Confidence Limit (LCL) of the Confidence interval

There are three steps to calculate the confidence interval on Pearson's correlation coefficient (r). The Lower Confidence Limit (LCL) (r′) is simply the left bound of the confidence interval.

### Step 1

Convert the value of Pearson's correlation coefficient (r) to a confidence interval (z) as:

$$z = 0.5 ln \frac{1 + r}{1 - r} \qquad ( S1 )$$

### Step 2

Calculate the confidence interval of z, expressed as z′, as:

$${z}^{′} = z \pm \frac{a}{\sqrt{N - 3}} \qquad ( S2 )$$

where,
a=1.96 for level of confidence or LCL at 97.5%; and
a=2.576 for level of confidence or LCL at 99.5%; the values for “a” were taken from the table of Appendix B (and determined in accordance with the description in Appendix B), the table entitled: Cumulative Normal Distribution,
N is the sample size (number of users).

### Step 3

Convert the confidence interval of z (expressed as z′) to the LCL value of r′ in accordance with the formula:

$${r}^{′} = \frac{{e}^{2 {z}^{′}} - 1}{{e}^{2 {z}^{′}} + 1} \qquad ( S3 )$$

### Part 4C—Applying Steps 1-3 to a 97.5% LCL to Establish a Lower Confidence Level (LCL) Value (r′)

If the correlation coefficient of target campaign and predictor campaign is calculated as r=0.7812 based on 10,000 users. The 97.5% LCL was calculated using formula S1, to obtain a value of z, such that z=1.0484.

A 97.5% lower confidence interval of z, with z=1.0484 (from above), expressed as z′, is LCL (97.5%), using the formula S2, where,

$${z}^{′} = 1.0484 \pm \frac{1.96}{\sqrt{( 1000 - 3 )}}$$

$${z}^{′} = 0.9863$$

whereby, the 97.5% confidence interval of r, expressed as r′, using the formula S3, where z′=0.9863 (from above), is:

$${r}^{′} = \frac{{e}^{2 {z}^{′}} - 1}{{e}^{2 {z}^{′}} + 1} = 0.7558$$

The above-described processes including portions thereof can be performed by software, hardware and combinations thereof. These processes and portions thereof can be performed by computers, computer-type devices, workstations, processors, micro-processors, other electronic searching tools and memory and other storage-type devices associated therewith. The processes and portions thereof can also be embodied in programmable storage devices, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments of the present invention have been described, so as to enable one of skill in the art to practice the present invention, the preceding description is intended to be exemplary only. It should not be used to limit the scope of the invention, which should be determined by reference to the following claims.

What is claimed is:

1. A method for determining the correlation between information to be distributed to recipients, comprising:
sending a first electronic communication corresponding to first information to a plurality of recipients, the first electronic communication being configured for being responded thereto;
sending a second electronic communication corresponding to second information to at least substantially all of the plurality of recipients of the first electronic communication, the second electronic communication being configured for being responded thereto;
receiving responses to the first electronic communication and the second electronic communication;
tabulating the received responses to the first electronic communication and the second electronic communication from the plurality of recipients, and non-responses to the first electronic communication and the second electronic communication from the plurality of recipients; and,
determining a correlation value between the first information and the second information, based on the tabulated responses and non-responses.

2. The method of claim 1, wherein the first information and the second information include advertising campaigns.

3. The method of claim 1, wherein the first electronic communication and the second electronic communication are electronic mail (e-mail).

4. The method of claim 3, wherein at least substantially all of the plurality of recipients of the first e-mail include all of the plurality of recipients of the first e-mail.

5. The method of claim 4, wherein the first e-mail and the second e-mail configured for being responded thereto, are configured for responses including opening the e-mail, and clicking on an activatable location in the image of the opened e-mail, to direct the browser associated with the computer of the recipient user to a targeted web site.

6. The method of claim 5, wherein, tabulating the responses to the first e-mail and the second e-mail from the plurality of recipients, and non-responses to the first e-mail and the second e-mail from the plurality of recipients, includes assigning values to the non-response, the e-mail being opened, and the opened e-mail being clicked.

7. The method of claim 6, wherein determining a correlation value between the first electronic communication and the second electronic communication, based on the tabulated responses and non-responses, includes, determining a correlation coefficient and analyzing the correlation coefficient for a value of a lower confidence limit.

8. The method of claim 7, wherein the correlation coefficient, expressed as r, is determined in accordance with the formula:
$$r = \frac{Σ XY - \frac{Σ X Σ Y}{N}}{\sqrt{( Σ {X}^{2} - \frac{{( Σ X )}^{2}}{N} ) ( Σ {Y}^{2} - \frac{{( Σ Y )}^{2}}{N} )}}$$
where,
X is responses and non-responses to the first e-mails corresponding to first information;
Y is responses and non-responses to the second e-mails corresponding to second information; and,
N is the number of the recipients of the plurality of recipients who were sent the first e-mails and the second e-mails.

9. A method for distributing informational campaigns comprising:
sending a plurality of recipients e-mails for a first informational campaign and a second informational campaign, the e-mails subject to responses from users, from a non-responded to status, to an opened status, to an activated status, where the recipient has opened the e-mail and the browser associated with the recipient has been directed to a target web site associated with the opened e-mail;
monitoring the e-mails for their status;
assigning values to the e-mails for the first informational campaign and the second informational campaign, in accordance with the monitored status of the e-mails; and
determining a correlation value between the first informational campaign and the second informational campaign based on values assigned to the e-mails for the first and second informational campaigns.

10. The method of claim 9, wherein the informational campaigns include advertising campaigns.

11. The method of claim 10, wherein the value for the non-responded to status is 0, the value for the activated status is 1, and the value for the opened status is between 0 and 1.

12. The method of claim 11, wherein determining a correlation value between the first electronic communication and the second electronic communication, based on the tabulated responses and non-responses, includes, determining a correlation coefficient and analyzing the correlation coefficient for a value of a lower confidence limit.

13. The method of claim 12, wherein the correlation coefficient, expressed as r, is determined in accordance with the formula:
$$r = \frac{Σ XY - \frac{Σ X Σ Y}{N}}{\sqrt{( Σ {X}^{2} - \frac{{( Σ X )}^{2}}{N} ) ( Σ {Y}^{2} - \frac{{( Σ Y )}^{2}}{N} )}}$$
where,
X is responses and non-responses to the first e-mails corresponding to the first advertising campaign;
Y is responses and non-responses to the second e-mails corresponding to the advertising campaign; and,
N is the number of the recipients of the plurality of recipients who were sent the first e-mails and the second e-mails.

14. The method of claim 10, additionally comprising: sending an electronic mail to an intended recipient for a second subsequent advertising campaign who has received an electronic mail for a first subsequent advertising campaign, the first subsequent campaign and the second subsequent campaign correlated to have the greatest correlation value.

15. A method for distributing informational campaigns comprising:
providing a plurality of informational campaigns;
determining the expected revenue for each campaign; and,
for each campaign having an expected revenue above a predetermined monetary value;
designating a first informational campaign and a second informational campaign;
sending a plurality of recipients e-mails for a first informational campaign and a second informational campaign, the e-mails subject to responses from users, from a non-responded to status, to an opened status, to an activated status, where the recipient has opened the e-mail and the browser associated with the recipient has been directed to a target web site associated with the opened e-mail;
monitoring the e-mails for their status;
assigning values to the e-mails for the first informational campaign and the second informational campaign, in accordance with the monitored status of the e-mails; and,
determining a correlation value between the first informational campaign and the second informational campaign based on values assigned to the e-mails for the first and second informational campaigns.

16. The method of claim 15, wherein the informational campaigns include advertising campaigns.

17. The method of claim 16, wherein the value for the non-responded to status is 0, the value for the activated status is 1, and the value for the opened status is between 0 and 1.

18. The method of claim 17, wherein determining a correlation value between the first electronic communication and the second electronic communication, based on the tabulated responses and non-responses, includes, determining a correlation coefficient and analyzing the correlation coefficient for a value of a lower confidence limit.

19. The method of claim 18, wherein the correlation coefficient, expressed as r, is determined in accordance with the formula:
$$r = \frac{Σ XY - \frac{Σ X Σ Y}{N}}{\sqrt{( Σ {X}^{2} - \frac{{( Σ X )}^{2}}{N} ) ( Σ {Y}^{2} - \frac{{( Σ Y )}^{2}}{N} )}}$$
where,
X represents the values for the status of each e-mail of the first advertising campaign;
Y represents the values for the status of each e-mail of the second advertising campaign; and,
N is the number of the plurality of recipients who were sent the e-mails.

20. The method of claim 16, additionally comprising: sending an electronic mail to an intended recipient for a second subsequent advertising campaign who has received an electronic mail for a first subsequent advertising campaign, the first subsequent campaign and the second subsequent campaign correlated to have the greatest correlation value.

21. The method of claim 15, wherein determining the expected revenue for each campaign includes:
designating one campaign of the plurality of campaigns a target campaign and another campaign of the plurality of campaigns a predictor campaign;
determining the probability that a recipient who responds to a predictor campaign will respond to a target campaign; and,
multiply the determined probability by a monetary value assigned to the target campaign.

22. The method of claim 21, wherein the probability that a recipient who responds to a predictor campaign will respond to a target campaign is determined from the set of recipients (SR) who responded to an e-mail for the predictor campaign by opening (O) or opening the e-mail for the predictor campaign and activating (C) the opened e-mail for the predictor campaign, so that their browser is directed to a target web site, in accordance with the formula:
P(T|P)=RT_{C}/RP_{O}+RP_{C}
where,
P (T|P) is the probability that a recipient who responds to a predictor campaign (P) will respond to a target campaign (T);
RT_{C} is the number of recipients who have activated an opened e-mail of the target campaign from the set SR, by clicking on a location in the image of the opened e-mail such that their browser has been redirected to a target web site;
RP_{O} is the number of recipients who have opened an e-mail of the predictor campaign from the set SR; and,
RP_{C} is the number of recipients who have activated an opened e-mail of the predictor campaign from the set SR, by clicking on a location in the image of the opened e-mail such that their browser has been redirected to a target web site;

23. The method of claim 22, wherein the monetary value assigned to the target campaign is a pay per click amount.

24. A system for determining the correlation between informational campaigns, to be sent to recipients, comprising:
a first component configured for sending a first electronic communication corresponding to a first informational campaign to a plurality of recipients, the first electronic communication being configured for being responded thereto, and for sending a second electronic communication corresponding to a second informational campaign to at least substantially all of the plurality of recipients of the first electronic communication, the second electronic communication being configured for being responded thereto;
a second component for receiving responses to the first electronic communication and the second electronic communication from the first component;
a third component for tabulating the received responses to the first electronic communication and the second electronic communication from the plurality of recipients, and non-responses to the first electronic communication and the second electronic communication from the plurality of recipients, from the second component; and,
a fourth component for determining a correlation value between the first informational campaign and the second informational campaign, based on the tabulated responses and non-responses, from the third component.

25. The system of claim 24, wherein the first informational campaign and the second informational campaign include advertising campaigns.

26. The system of claim 24, wherein the first component is configured for sending the first and second electronic communications as electronic mail (e-mail).

27. The system of claim 26, wherein the first component is configured to create the first e-mail and the second e-mail for being responded to, by responses including opening the e-mail, and clicking on an activatable location in the image of the opened e-mail, to direct the browser associated with the computer of the recipient user to a targeted web site.

28. The system of claim 27, wherein, the third component is configured for assigning values to non-responses to each e-mail, each e-mail being opened, and the each opened e-mail being clicked.

29. The system of claim 28, wherein the fourth component for determining a correlation value between the first electronic communication and the second electronic communication, based on the tabulated responses and non-responses, is configured for, determining a correlation coefficient and analyzing the correlation coefficient for a value of a lower confidence limit.

30. A computer-usable storage medium having a computer program embodied thereon for causing a suitably programmed system to determine the correlation between two informational campaigns, by performing the following steps when such program is executed on the system:
sending a first electronic communication corresponding to a first informational campaign to a plurality of recipients, the first electronic communication being configured for being responded thereto,
sending a second electronic communication corresponding to a second informational campaign to at least substantially all of the plurality of recipients of the first electronic communication, the second electronic communication being configured for being responded thereto;
receiving responses to the first electronic communication and the second electronic communication;
tabulating the received responses to the first electronic communication and the second electronic communication from the plurality of recipients, and non-responses to the first electronic communication and the second electronic communication from the plurality of recipients, and,
determining a correlation value between the first informational campaign and the second informational campaign, based on the tabulated responses and non-responses.

31. The computer-usable storage medium of claim 30, wherein the first informational campaign and the second informational campaign include advertising campaigns.

32. The computer-usable storage medium of claim 30, additionally comprising the step of: sending the first and second electronic communications as electronic mail (e-mail).

33. The computer-usable storage medium of claim 32, wherein receiving responses includes, providing for the opening the e-mails and directing the browser associated with the computer of the recipient user to a targeted web site, when the user activates an activatable location in the image of the opened e-mail.

34. The computer-usable storage medium of claim 33, wherein the step of tabulating the responses to the first and second e-mails includes assigning values to non-responses to each e-mail, each e-mail being opened, and the each opened e-mail being clicked.

35. The computer-usable storage medium of claim 34, wherein the step of determining a correlation value, includes the step of determining a correlation coefficient and analyzing the correlation coefficient for a value of a lower confidence limit.
